(19) United States
(12) Patent Application Publication
(10) Pub. No.: US 2005/0065839 A1
(43) Pub. Date: Mar. 24, 2005

(54) Methods, systems and computer program products for generating an aggregate report to provide a certification of controls associated with a data set

(76) Inventors: Debra Benson, Marietta, GA (US); Janet McKinley, Roswell, GA (US); Stephanie Jemison Smith, Mableton, GA (US); Charles Lathram, Duluth, GA (US); Guy Cochran, Douglasville, GA (US); Raymond Winborne, Cumming, GA (US); James Woodall, Canton, GA (US); Edward Martinez, Acworth, GA (US)

Correspondence Address: MYERS BIGEL SIBLEY & SAJOVEC, P.A., P.O. BOX 37428, RALEIGH, NC, 27627, US

(21) Appl. No.: 10/794,446

(22) Filed: Mar. 5, 2004

Related U.S. Application Data
(60) Provisional application No. 60/504,898, filed on Sep. 22, 2003.
(60) Provisional application No. 60/504,804, filed on Sep. 22, 2003.

(51) Int. Cl. G06F 17/60

(52) U.S. Cl. 705/10; 705/35

(57) ABSTRACT

Methods for generating an aggregate report to provide a certification of controls associated with a data set include identifying sources that generate information to be included in the data set. A plurality of controls associated with the identified sources are identified. At least one of the controls is selected as a key control. The key control is tested to assess its efficacy as a control for its identified source. The key control is modified to adjust its efficacy based on the testing of the key control when the efficacy fails to satisfy a criterion. An aggregate report is generated on the plurality of controls based on the testing of the key control to provide a certification of the controls associated with the data set.

### RELATED APPLICATION

This application claims the benefit of and priority from U.S. Provisional Patent Application Nos. 60/504,898, and 60/504,804 each filed Sep. 22, 2003, the disclosures of which are hereby incorporated herein by reference as if set forth in their entireties.

### BACKGROUND OF THE INVENTION

The present invention relates to data maintained by an entity and, more particularly, to controls over such data.

For a variety of different data maintained by business entities, it is sometimes necessary to comment on not only the data but on the controls for the systems and processes in place within the business entity that generate the data. In particular, the need to comment on the controls associated with data of a business entity is obtaining a great deal of attention in the area of financial data of publicly held business entities in response to various alleged instances of manipulation of financial reports by management of various publicly held business entities.

In response to concerns over the reliability of the financial reports generated by publicly held business entities, the Sarbanes-Oxley Act has been adopted in the United States. Sections 302 and 404 of the Sarbanes-Oxley act include requirements for covered business entities, including requiring a management assertion providing a certification of the internal controls of the business entity for financial reporting. The management assertion under Sarbanes-Oxley includes an assessment of the effectiveness of the internal controls as well as a statement of management responsibility for establishing and maintaining the controls and the framework used to evaluate the effectiveness of the controls.

### SUMMARY OF THE INVENTION

Embodiments of the present invention provide for generating an aggregate report to provide a certification of controls associated with a data set. Sources that generate information to be included in the data set are identified and a plurality of controls associated with the identified sources are identified. At least one of the controls is selected as a key control. The key control is tested to assess its efficacy as a control for its identified source. The key control may be modified to adjust its efficacy based on the testing of the key control when the efficacy fails to satisfy a criterion. An aggregate report on the plurality of controls is generated based on the testing of the key control to provide a certification of the controls associated with the data set.

In further embodiments of the present invention, the data set is financial data for a business entity. The business entity includes one or more business units having ownership of the identified sources and a financial unit. Ones of the business units identify controls associated with sources owned by the respective ones of the business units. The financial unit selects the at least one key control and tests the key control. The business unit having ownership of the key control modifies the key control.

In other embodiments of the present invention, identifying sources that generate information includes identifying primary sources that provide the information to be included in the data set and identifying secondary sources that provide information to the identified primary sources for use in generating the information to be included in the data set.

In further embodiments of the present invention, selecting at least one of the controls as a key control includes determining at least one risk criterion and identifying at least one of the controls as a key control based on the at least one risk criterion. Testing the key control may include designing a test for the key control, testing the key control based on the designed test and assessing the efficacy of the key control based on the testing of the key control. Modifying the key control may include providing training to an entity having ownership of the identified source associated with the key control and notifying the entity of the efficacy of the key control to provide the entity a basis to modify the key control.

In other embodiments of the present invention, a report generated from the data set is analyzed to identify information included in the report that is not generated by the identified sources. A key control for a source associated with information included in the report that is not generated by the identified sources is selected and tested. Generating the aggregate report includes generating the aggregate report based on the selected and tested key control for the source associated with information included in the report that is not generated by the identified sources.

In yet further embodiments of the present invention, generating an aggregate report to provide a certification of controls associated with financial data for a business entity includes receiving an identification of a plurality of controls associated with sources that generate the financial data from at least one business unit of the business entity having ownership of the sources. At least one of the controls is selected as a key control. The key control is tested to provide an assessment of its efficacy as a control for its associated source. The assessment is provided to the at least one business unit having ownership of the associated source when the key control fails to satisfy a criterion to allow modification of the key control to adjust its efficacy. An aggregate report on the plurality of controls is generated, based on the testing of the at least one key control, for a manager of the business entity responsible for certification of the controls associated with the financial data.

A financial unit of the business entity may select and test the at least one key control and generate the aggregate report. The financial data may be entries of a general ledger of the business entity and certifying controls may include certifying controls associated with a financial report of the business entity generated based on the general ledger. The financial data may further include a financial report from a business unit of the business entity, such as a foreign subsidiary of the business entity.

In other embodiments of the present invention, the sources that generate the financial data are identified. Identifying the sources that generate the financial data may include identifying primary sources that provide the financial data and identifying secondary sources that provide information to the identified primary sources for use in generating the financial data. In addition, tertiary sources that provide information to the identified secondary sources for use in generating the information provided by the secondary sources to the primary sources may be identified for some of the sources.

In further embodiments of the present invention, selecting at least one of the controls as a key control includes determining at least one tolerance criterion and identifying at least one of the controls as a key control based on the at least one tolerance criterion. Determining at least one tolerance criterion may include determining a dollar criterion and a risk criterion. Identifying at least one of the controls as a key control may include identifying controls that satisfy the dollar criterion and controls that satisfy the risk criterion as key controls. Determining a risk criterion may include determining a criterion based on risk of manual intervention generating an error in the financial data and/or a criterion based on a geographic location associated with a source of the financial data. The dollar criterion may be based on revenue, asset flow, expenses and/or net income.

In other embodiments of the present invention, selecting at least one of the controls as a key control includes receiving information regarding the identified controls generated by the at least one business unit having ownership of the sources associated with the identified controls. The received information is analyzed to identify deficiencies in the received information. Additional information is requested regarding the identified controls generated by the at least one business unit having ownership of the sources associated with the identified controls to address any identified deficiencies in the received information. At least one of the controls is selected as a key control based on the received information and/or the additional information.

In further embodiments of the present invention, selecting at least one of the controls as a key control includes identifying a plurality of control categories and selecting at least one control from each of the identified control categories as a key control. The control categories may include completeness of inputs to the general ledger, completeness of updates to the general ledger, accuracy of inputs to the general ledger, accuracy of updates to the general ledger, authorization, continuity, timeliness, access restriction and/or segregation of duties. Testing the key control may include designing a test for the key control, testing the key control based on the designed test and assessing the efficacy of the key control based on the testing of the key control.

In other embodiments of the present invention, modifying the key control includes providing training to the at least one business unit having ownership of the source associated with the key control to the at least one business unit having ownership of the source associated with the key control and notifying the business unit having ownership of the source associated with the key control of the efficacy of the key control to provide the business unit having ownership of the source associated with the key control a basis to modify the key control. The method may further include analyzing the financial report of the business entity to identify information included in the financial report that is not generated by the identified sources and selecting and testing at least one key control for a source associated with identified information included in the financial report that is not generated by the identified sources. Generating an aggregate report in such embodiments further includes generating the aggregate report based on the selected and tested at least one key control for the source associated with identified information included in the financial report that is not generated by the identified sources.

The business entity may be a publicly held business entity. The financial report may be a report required by government regulations of publicly held business entities. Certifying controls may be an assertion by management of the business entity that the controls associated with the financial report satisfy requirements specified by the government regulations. The sources may be a process and/or a system of the business entity.

In further embodiments of the present invention, systems for generating an aggregate report to provide a certification of controls associated with a data set are provided. The systems include means for receiving an identification of controls associated with sources of information to be included in the data set and an identification of at least one entity having ownership of the sources and means for receiving an identification of ones of the identified controls as key controls and for receiving verification of testing of the key controls. The systems further include means for generating the aggregate report based on the verification of testing of the key controls. In some embodiments, the systems also include means for registering users to control access to information used in generating the aggregate report.

In other embodiments of the present invention, the means for receiving an identification of controls further includes means for receiving a description of the sources of information and the means for receiving an identification of controls further includes means for receiving a description of the controls. The description of the controls may include a designation of a control category for the controls.

Other systems, methods and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a schematic block diagram illustrating a business entity system including some embodiments of the present invention;

FIG. 2 is a block diagram of a data processing system suitable for use in some embodiments of the present invention;

FIG. 3 is a more detailed block diagram of aspects of a data processing system that may be used in some embodiments of the present invention;

FIG. 4 is a flow chart illustrating operations for generating an aggregate report according to some embodiments of the present invention;

FIG. 5 is a flow chart illustrating operations for generating an aggregate report related to financial data according to further embodiments of the present invention;

FIG. 6 is a flow chart illustrating operations for generating an aggregate report related to a financial report generated by a publicly held business entity subject to the Sarabanes-Oxley Act according to some embodiments of the present invention;

FIG. 7 is a control model template suitable for use in some embodiments of the present invention;

FIG. 8 is an input screen for accessing a data base according to some embodiments of the present invention;

FIG. 9 is an input screen for inputting a process description according to some embodiments of the present invention; and

FIG. 10 is an input screen for inputting control descriptions according to some embodiments of the present invention.

### DETAILED DESCRIPTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein the term “and/or” includes any and all combinations of one or more of the associated listed items.

As will be appreciated by one of skill in the art, the present invention may be embodied as a method, data processing system or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described in part below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

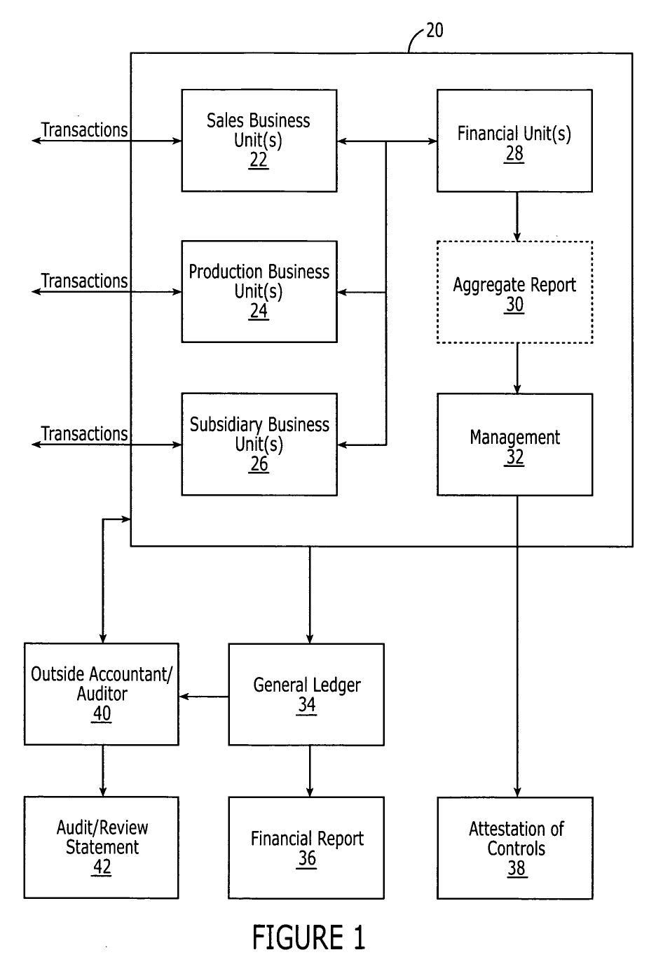

Embodiments of the present invention will now be described with reference to the various embodiments illustrated in FIGS. 1 to 10. FIG. 1 is a schematic illustration of a business entity environment including embodiments of the present invention. As seen in FIG. 1, a business entity 20 includes a number of different business units 22, 24, 26, 28. As further illustrated in FIG. 1, the business units include sales business unit(s) 22, production business unit(s) 24, subsidiary business unit(s) 26, such as a foreign subsidiary, and financial unit(s) 28. The units 22, 24, 26, 28 engage in various transactions that generate entries into the general ledger 34 of the business entity 20. Exemplary transactions include sales of products/services provided by the production business unit(s) 24, purchases of expense items used in the operations of the business entity 20, payroll for employees and/or changes in the assets of the business entity 20.

The financial unit(s) 28 illustrated in FIG. 1 may be, for example, an internal audit (IA) department or professional. Additional financial functions of the business entity 20 may also be included in the financial unit(s) 28 or may be included as part of the other business units 22, 24, 26. In addition, management 32 is shown in FIG. 1, separate from the units 22, 24, 26, 28. It will be understood that management 32 represents the management group responsible for attesting to the financial controls of the business entity 20 and that such management may be part of one or more of the business units 22, 24, 26, 28. Furthermore, the business units 22, 24, 26, 28 will generally include managers responsible for operation of those units, who may be distinct managers from management 32.

In accordance with various embodiments of the present invention, the financial unit(s) 28 provides an aggregate report on financial controls on systems and processes (sources of financial data) of the business entity 20 to management 32 to support generation of a management attestation 38 regarding such controls in relation to a financial report 36 of the business entity 20 generated based, in part, on the general ledger 34. As also shown in FIG. 1, an outside accountant/auditor 40 may also review the general ledger 34 and the financial report 36 and communicate with the business units of the business entity 20 to provide an audit/review statement 42 on the financial report 36.

The financial controls may be based, for example, on the Committee of Sponsoring Organizations (COSO) control model. The COSO control model is one standard that may be used for financial controls, such as the financial controls certified by a company under the Sarbanes-Oxley Act. However, other standards may be used in accordance with various embodiments of the present invention.

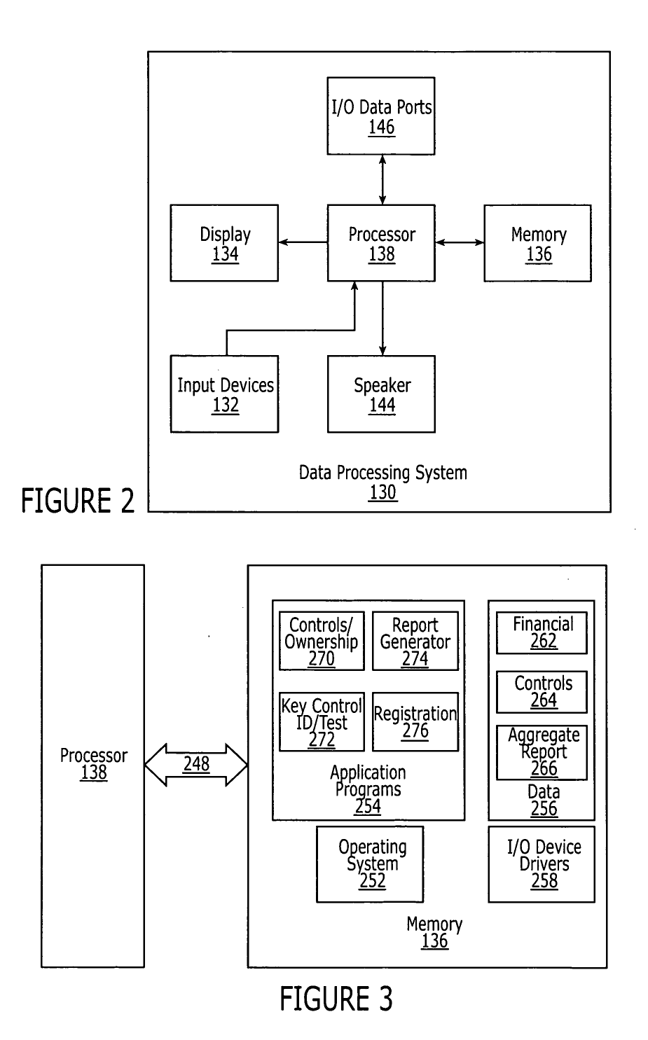

FIG. 2 illustrates an exemplary embodiment of a data processing system 130 suitable for use in accordance with embodiments of the present invention. The data processing system 130 typically includes input device(s) 132 such as a keyboard, pointer, mouse and/or keypad, a display 134, and a memory 136 that communicate with a processor 138. The data processing system 130 may further include a speaker 144, and an I/O data port(s) 146 that also communicate with the processor 138. The I/O data ports 146 can be used to transfer information between the data processing system 130 and another computer system or a network. These components may be conventional components, such as those used in many conventional data processing systems, which may be configured to operate as described herein.

FIG. 3 is a block diagram of data processing systems that illustrates systems, methods, and computer program products in accordance with embodiments of the present invention. The processor 138 communicates with the memory 136 via an address/data bus 248. The processor 138 can be any commercially available or custom microprocessor. The memory 136 is representative of the overall hierarchy of memory devices, and may contain the software and data used to implement the functionality of the data processing system 130. The memory 136 can include, but is not limited to, the following types of devices: cache, ROM, PROM, EPROM, EEPROM, flash memory, SRAM, and DRAM.

As shown in FIG. 2, the memory 136 may include several categories of software and data used in the data processing system 130: the operating system 252; the application programs 254; the input/output (I/O) device drivers 258; and the data 256. As will be appreciated by those of skill in the art, the operating system 252 may be any operating system suitable for use with a data processing system, such as OS/2, AIX, System390 or z/OS from International Business Machines Corporation, Armonk, N.Y., Windows95, Windows98, Windows2000 or WindowsXP from Microsoft Corporation, Redmond, Wash., Unix or Linux. The I/O device drivers 258 typically include software routines accessed through the operating system 252 by the application programs 254 to communicate with devices such as the I/O data port(s) 146 and certain memory 136 components. The application programs 254 are illustrative of the programs that implement the various features of the data processing system 130 and preferably include at least one application that supports operations according to embodiments of the present invention. Finally, the data 256 represents the static and dynamic data used by the application programs 254, the operating system 252, the I/O device drivers 258, and other software programs that may reside in the memory 136.

As is further seen in FIG. 3, the application programs 254 may include a controls/ownership module 270, a key control identity/testing module 272, a report generator module 274 and a registration module 276. The modules 270, 272, 274, 276 may carry out the operations described herein for generating an aggregate report to provide a certification of controls associated with a data set, such as a financial data set, utilizing data, such as the financial data 262, controls data 264, and aggregate report data 266. The controls/ownership module 270 provides means for receiving an identification of controls associated with sources of information included in the data set and an identification of at least one entity having ownership of the sources. It will be understood that the owning entity may be a business unit, such as the business units 22, 23, 24, 26, 28 described with referenced to FIG. 1, and that any one business unit may have ownership of a number of different sources generating information to be included in the data set, such as the general ledger 34.

The key control identification/testing module 272 provides a means for receiving an identification of ones of the identified controls as key controls and for receiving verification of testing of the key controls. For example, an IA department, such as the financial unit 28 may evaluate information regarding controls over financial data from the business units 22, 24, 26 and identify key controls and then test those controls as will be more fully described later herein. The report generator module 274 provides a means for generating the aggregate report 30 based on the verification of testing of the key controls as received by the key control identification/testing module 272.

In some embodiments of the present invention, the registration module 276 is provided to control access to information used in generating the aggregate report 30. For example, the registration module 276 may include a user registration interface having password protection or other means of validating that a user entering data into the system is authorized to enter such data.

The controls/ownership module 270 may further provide for receiving a description of the sources of the information, such as a designation of the particular system or process of a business entity 20 generating the information, and for receiving a description of the controls associated with such sources. As will be described more fully herein, the description of the controls may include a designation of a control category for the controls. The control categories may be specified by the financial unit 28 and/or by the business unit 22, 24, 26 having ownership of the source associated with the control.

While the financial data 262 and controls data are illustrated in the embodiments of FIG. 3 as being distinct data sets, a single data set could be used for storing all related data. Similarly, while the aggregate report data 266 is illustrated as a distinct data set, the aggregate report 30 may be generated from a data set including the financial data 262 and controls data 264 to generate an aggregate report 30 for management attestation without storing the aggregate report data 266 as a separate data set. It will also be understood that the financial data 262 is the data generated by the various sources providing information to the data set for which an aggregate report is being generated as described further herein.

While the present invention is generally described herein with reference to embodiments related to financial data, it will be understood that other embodiments of the present invention may be related to different types of data, for example, data related to drug testing to be submitted for government approvals and the like.

While the present invention is illustrated, for example, with reference to the controls/ownership module 270 and the like being application programs in FIG. 3, as will be appreciated by those of skill in the art, other configurations may also be utilized. For example, the controls/ownership module 270 may also be incorporated into the operating system 252, the I/O device drivers 258 or other such logical division of the data processing system 130. Thus, the present invention should not be construed as limited to the configuration of FIG. 3 but encompasses any configuration capable of carrying out the operations described herein.

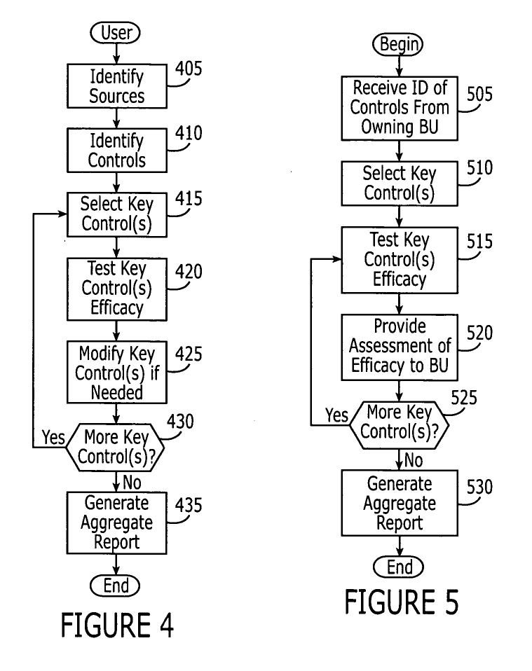

Operations according to some embodiments of the present invention will now be described with reference to the flowchart illustration of FIG. 4. As shown in the embodiments of FIG. 4, operations for generating an aggregate report to provide a certification of controls associated with the data set begin at Block 405 with identifying sources that generate information to be included in the data set. The sources may, for example, be processes or systems (either manual or automated) of a business entity 20 that generate the information to be included in the data set. In particular embodiments of the present invention, the data set is financial data for a business entity that includes one or more business units having ownership of the identified sources as well as a financial unit, such as an IA department. Both primary sources of information and secondary sources providing information to the primary sources for use in generating information to be included in the data set, and so on, may be identified at Block 405.

A plurality of controls associated with the identified sources are identified (Block 410). For example, ones of the business units may identify controls associated with sources owned by the respective ones of the business units. At least one of the controls is selected as a key control (Block 415). For example, the data set may be financial data and a financial unit, such as an IA department, may select the key control(s). As will be described more fully herein, selecting a key control at Block 415 may include identifying at least one tolerance criterion, such as a risk criterion, and identifying the key control(s) based on the at least one tolerance criterion. The key control is tested to assess its efficacy as a control for its identified source (Block 420). For example, the IA department may test the key control and, in particular embodiments of the present invention, may further design the test for the key control in addition to executing the test and assessing the efficacy of the key control based on the testing.

When the efficacy fails to satisfy a criterion, such as a minimum efficacy criterion, operations in some embodiments of the present invention include modifying the key control to adjust its efficacy based on the testing of the key control (Block 425). For example, notification may be provided to a business unit having ownership of the source associated with the key control so that the business unit may modify the control to improve its efficacy. The testing unit, such as the IA department of the business entity may provide training to the owning business unit and notification to the owning business unit of the need to modify the key control so as to allow modification of the key control by the business unit.

At Block 430, it is determined whether there are additional key controls to be selected and tested. If so, operations at Blocks 415, 420 and 425 are repeated until all the key controls have been identified. Once all the key controls have been selected and tested and, if necessary, modified (Block 430), an aggregate report on the plurality of controls is generated based on the testing of the key controls to provide a certification of the controls associated with the data set (Block 435).

As will be described further herein with respect to specific embodiments of the present invention related to financial data, further operations may be performed before generating the aggregate report at Block 435. For example, a report may be generated from the data set and the report so generated may then be analyzed to identify information included in the report that is not generated by any of the already identified sources. One or more key controls may then be selected and tested for sources associated with information included in the report that is generated by sources not already identified. Generating the aggregate report at Block 435 may then include generating the report based on the selected and tested key control for the source(s) associated with information included in the report that is not generated by the previously identified sources to provide a more complete aggregate report characterizing controls related to the report generated from the data set.

Operations related to further embodiments of the present invention for generating an aggregate report to provide a certification of controls associated with financial data for a business entity will now be described with reference to the flow chart illustration of FIG. 5. Operations begin at Block 505 with receipt of an identification of a plurality of controls associated with sources that generate financial data from at least one business unit of the business entity having ownership of the sources. At least one of the controls is selected as a key control (Block 510). The key control is tested to provide an assessment of its efficacy as a control for its associated source (Block 515). The assessment of the efficacy of the control is provided to the respective business unit having the ownership of the source associated with the control when the key control fails to satisfy a criterion to allow modification of the key control by the business unit to adjust its efficacy (Block 520). If additional key controls remain to be selected, tested and, if necessary, modified (Block 525) the operations at Blocks 510, 515, and 520 are repeated. After all the key controls have been selected and tested, an aggregate report is generated on the plurality of controls, based on the tested of the key control(s), for a manager of the business entity responsible for certification of the controls associated with the financial data (Block 530).

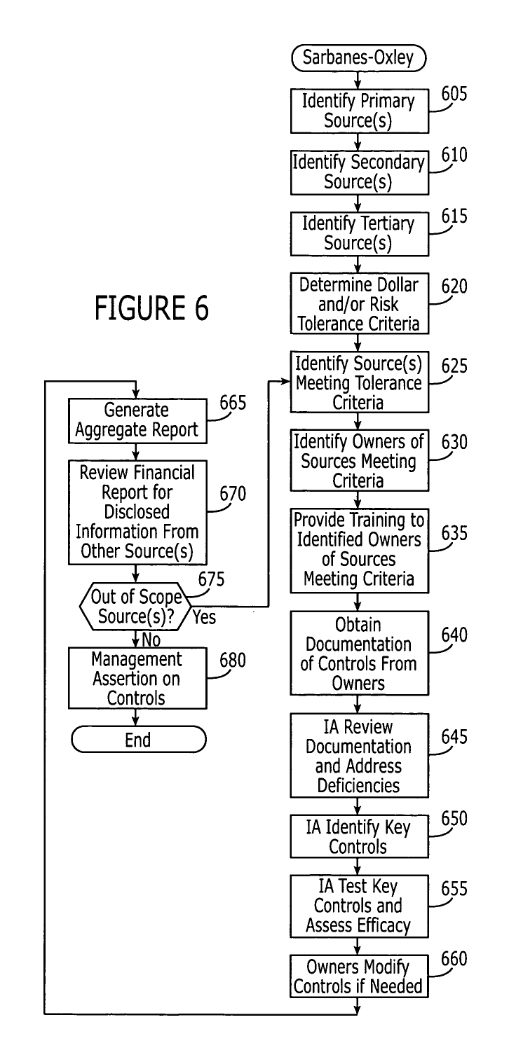

Operations of particular embodiments of the present invention suitable for use in addressing Sections 302 and 404 of the Sarbanes-Oxley Act by aggregating information at a level required by such legislation and a management assertion based on such information will now be further described with referenced to the flow chart illustration of FIG. 6. Following a process such as illustrated in FIG. 6 may allow for identification of controls of a business activity that are truly key to producing a reliable financial statement even though, arguably, controls around every activity of a business unit could affect financial information at some level. The illustrated process may further beneficially provide a repeatable and supportable basis allowing for attestation of control conditions by external audit firms 40 as well as by management 32 of a business entity 20.

Various of the operations described with reference to FIG. 6 may be carried out manually and, in some instances, by use of computer systems and software support implemented in custom code or by customizing available software systems, such as Risk Navigator™ available from Paisley Consulting. For the embodiments to be described with reference to FIG. 6, the financial data includes entries of a general ledger of a business entity and may further include financial reports from one or more business units of the business entity 10, such as foreign subsidiaries 26. The certification of controls and management attestation to such controls may be certification of controls associated with financial reports 36 of a business entity generated based on the general ledger 34 as required by the Sarbanes-Oxley Act.

Operations begin at Block 605 by identifying primary sources that provide the financial data, such as systems or processes that feed information to the general ledger 34. Secondary sources are identified that provide information to the identified primary sources for use in generating the financial data (Block 610). In some embodiments, tertiary sources that provide information to the identified secondary sources for use in generating the information provided by the secondary sources to the primary sources are also identified (Block 615). The number of steps back in tracing information associated with the financial data included in the general ledger 34 may be varied based upon the criticality of the particular information or the like in various embodiments of the present invention.

At least one tolerance criteria is determined, such as a risk criterion and/or a dollar criterion (Block 620). A risk criterion may be based, for example, on the risk of manual intervention generating an error in the financial data and/or based on a geographic location associated with the source of the financial data. For example, where the financial data is a financial report provided by a foreign subsidiary of the business entity located in a country associated with a high political and/or economic instability, such data may be considered to have a higher risk. The dollar criterion may be generated based on a variety of different financial characteristics of the financial data, such as revenue amount, asset flow amount, expense amount and/or net income. One or more risk criterion and/or dollar criterion may be associated with a single source.

Sources meeting the tolerance criteria are identified (Block 625). A source may be identified based on satisfying one or both of a dollar criterion and a risk criterion. The business unit having ownership of an identified source meeting the tolerance criteria are identified (Block 630) and provided control training, for example, by an IA department of the business entity (Block 635). The documentation of controls associated with the financial data is obtained from the trained owners (Block 640).

An IA professional may review the provided documentation and may work with owners of identified sources to close any documentation gaps, i.e., correct any identified deficiencies, that may exist in the obtained documentation (Block 645). In addition to receiving and analyzing the information, the IA professional may request additional information to address any identified deficiencies in the received information. The IA professional identifies key control(s) for each source, for example, based on the provided documentation (Block 650). Identifying key controls may include identifying a plurality of control categories and selecting at least one control from each of the identified control categories as a key control as will be described further later herein.

The IA professional tests the identified key controls to assess their efficacy as a control for the associated sources of information (Block 655). The IA professional may design tests for the key control, test the key control based on the designed tests and then provide an assessment of efficacy based on the testing.

If necessary, owners of respective sources of information take steps to address any control weakness identified during testing by modifying the controls as needed (Block 660). An IA professional may provide training to an owning business unit and notify the business unit if the efficacy of a control fails to meet expectations to provide the business unit a basis to modify a control.

The aggregate report 30 is generated, for example, by the financial unit 28 (such as an IA professional) (Block 665). The generated aggregate report may include key financial control conditions identified and assessed as described in the preceding steps. In some embodiments of the present invention, the financial report 36 for which the attestation of controls 38 is generated by the management 32 is reviewed to identify any disclosed information that is not generated by a source considered in generating the aggregate report at Block 665 (Block 670). For example, financial footnotes to a financial report such as a Securities and Exchange Commission (SEC) 10K report, may be reviewed. If any out of scope sources (i.e., sources not considered in identifying and testing key controls for inclusion in the generated aggregate report as such sources were not included in the scope of review) are found (Block 675), operations return to Block 630 to generate the necessary information associated with such newly identified sources to update and include them in the aggregate report generated at Block 665. If no such out of scope sources are identified (Block 675), or if any such identified sources have been included in the aggregate report, management 32 generates its assertion on the financial controls 38 for the financial report 36 (Block 680).

Operations as described above with respect to FIG. 6 may be used by a business entity that is a publicly held business entity subject to the requirements of the Sarbanes-Oxley Act in support of the financial reports, such as SEC required reports generated by the business entity pursuant to other government regulations of publicly held business entities. As a result, management assertions as required under Section 302 and Section 404 of the Sarbanes-Oxley Act may be systematically and repeatedly provided by management 32.

Its is to be understood that, while the financial data embodiments of the present invention are generally described above with reference to financial reporting purposes required by government regulations, the aggregate report generation of embodiments of the present invention may also be utilized for other aspects of a business entity. For example, an identified control may include the cost of processing an invoice for a given business entity compared to the average to carry out the same activity in other companies. Such types of control related to a cost of doing business may help a business identity situations where operations or processes of the business entity could be beneficially streamlined. Thus, such information may be useful to a business entity even though it does not have an impact on the accuracy of the financial statements and need not be utilized for certifications required by government regulations. It is also to be understood that, in some embodiments of the present invention, modifying a key control after the key control is identified may include a review of other controls to see if they provide assurances making the identified weaknesses of the key control be reliable enough that no modification is required. Furthermore, rather than modify the process or system associated with a key control to address a deficiency, it may be more appropriate in some circumstances to reconsider the selection of key controls and choose a different one of a plurality of controls associated with a source as a key control rather than modifying the originally selected key control. All such variations are understood to be included within the scope of the present invention.

In various embodiments of the present invention, it may be desirable to begin by identifying all entities falling within the scope of the assessment of financial or other data controls and document entity level controls for such in scope business entities before documenting the process/system level controls associated with identified sources of information. Entity level control documentation may include documentation related to control environment (e.g., ethics, board governance, policies and/or procedures), risk assessment (e.g., how to identify and react to changes in business risk), information and communication (e.g., business continuity and disaster recovery plans, performance reporting), control activities (e.g., policies and procedures, segregation of duties and/or access controls) and monitoring (e.g., internal audit and/or periodic evaluation of internal controls).

In other embodiments of the present invention, once set in place, automated systems may be provided that allow for monitoring of the control and aggregate report generation system in a changing business environment. For example, a web-based system utilizing Risk Navigator™ may be used to document and track compliance by business units including incorporating control testing detail, issue monitoring and summarized control testing and conclusions. Process or system owners may be held accountable as documented by this data processing system for the accuracy of their control information and may be asked to validate and update this information periodically with the system tracking validation in a timely manner. The system may also be tied into the internal audit system or the like used by the business entity. Thus, the process or system owners may be held responsible for insuring the results of their owned process or system sources as being accurate, timely and authorized. The process owners may work with both internal audit and information technology support personnel in identifying and documenting controls in place over both manual and automated computer based processes. In a financial context, the primary focus may be directed to controls that assure that dollar amounts entered into the systems are correct.

In particular embodiments of the present inventions, controls are associated with an identified plurality of control categories. For example, different control categories may include the completeness of inputs to the general ledger, completeness of updates to the general ledger, accuracy of inputs to the general ledger, accuracy of updates to the general ledger, authorization, continuity, timeliness, restricted access and/or segregation of duties. The completeness of input control category may include controls designed to ensure that all transactions are initially recorded, submitted to a financial computer, accepted by the computer, including reporting rejected transactions and/or processed only once, including reporting duplicated transactions. The computer being controlled may be a separate computer system from that which supports operations according to embodiments of the present invention. Various suitable techniques for completeness of input controls include one-to-one, batch totaling, matching and/or sequence checks.

The accuracy of input control category may be directed to controls on how a business knows what is initially received accurately reflects the reality of the financial condition of the business and remains accurate while the aggregate report is being generated. Accuracy of input controls may be designed to insure that errors in significant data fields are detected when transactions are initially recorded, converted to machine readable format and/or accepted by the computer collecting the financial or other data. Applicable techniques for such type controls include one-to-one checking, batch totals, matching key verification, programmed edits and/or pre-recorded input.

The authorization control category may be directed to knowing whether activities have been properly authorized. Controls in this category may be designed and implemented to ensure that only those transactions that are correct and in accordance with managements intentions are processed. Suitable techniques for this control category may include match of master file conditions to other master files, match of master file conditions to transaction, match of master file conditions to previously determined conditions, evaluation of historical activities on master files, manual review of exception conditions on transactions and/or manual review of actual results through pre-approved plans and budgets.

The completeness of update control category may be directed to how a business knows it has included everything about the process leading up to the management attestation of controls. Controls in this category may be designed to insure that all transactions, once accepted by the computer, are updated on the appropriate master files. Suitable techniques include control total, matching, sequence checks and/or one-to-one checking.

The accuracy of update control category may be associated with how a business knows what is included in a report reflects reality and remains correct throughout the process. Controls associated with this category may be designed to ensure that significant data fields are accurately updated on the appropriate files. Suitable techniques include one-to-one checks, batch totals, programmed edit checks, previously entered matching of data and/or re-performance of programmed procedures.

The continuity control category may be directed to determining if there is an indicator or activity that notifies the information users that data remains current and correct between process cycles. Controls associated with this category may include controls designed to insure that data remains correctly stored on the files and also remains current and/or two parts of continuity including is the data going to stay there and whether it is going to stay current and accurately reflect business conditions. Suitable techniques for this category may include correct control totals, correct exception reports and correct exception and correct control records.

The timeliness control category may be directed to identifying how a business knows an activity is timely. Controls associated with this category may be designed to ensure that updates of the books and records happen within an appropriate time frame of when associated events occur. Systems suitable for use in this category include batch, on-line and/or real-time using techniques such as program logic and supervisor involvement.

The segregation of duties control category may be directed to identifying functions where conflicts of interest could occur to be sure that they are appropriately segregated. Controls in this category may be designed to ensure that responsibilities where fraud could be committed are performed by different groups/individuals, inadvertent or intentional errors are detected and prevented and/or the books and records are not distorted.

For the restricted access control category, the controls may be directed to determining if access is restricted to only those who are authorized to use the information. These controls may be designed to ensure that only those that need to get into the system can do so and that users are restricted to doing only what they should be able to do in the system. Investigation of this control category may include determining who can access the system and what their rights are as well as profiles and what machines they are allowed to use.

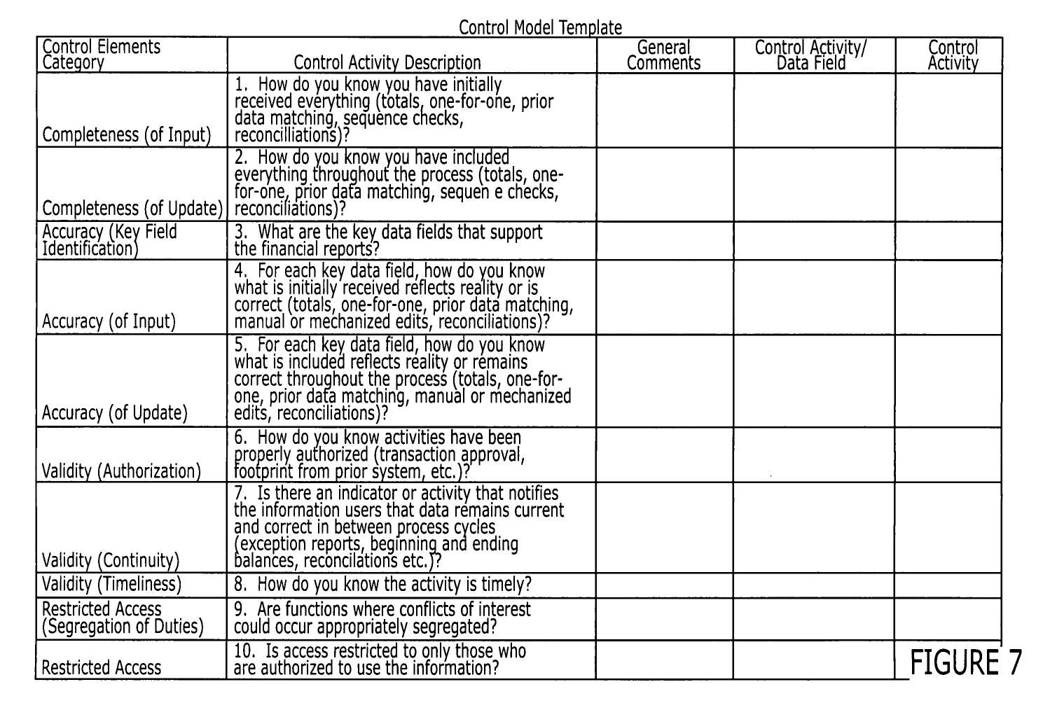

A control module template suitable for use with the control categories described above is illustrated in FIG. 7.

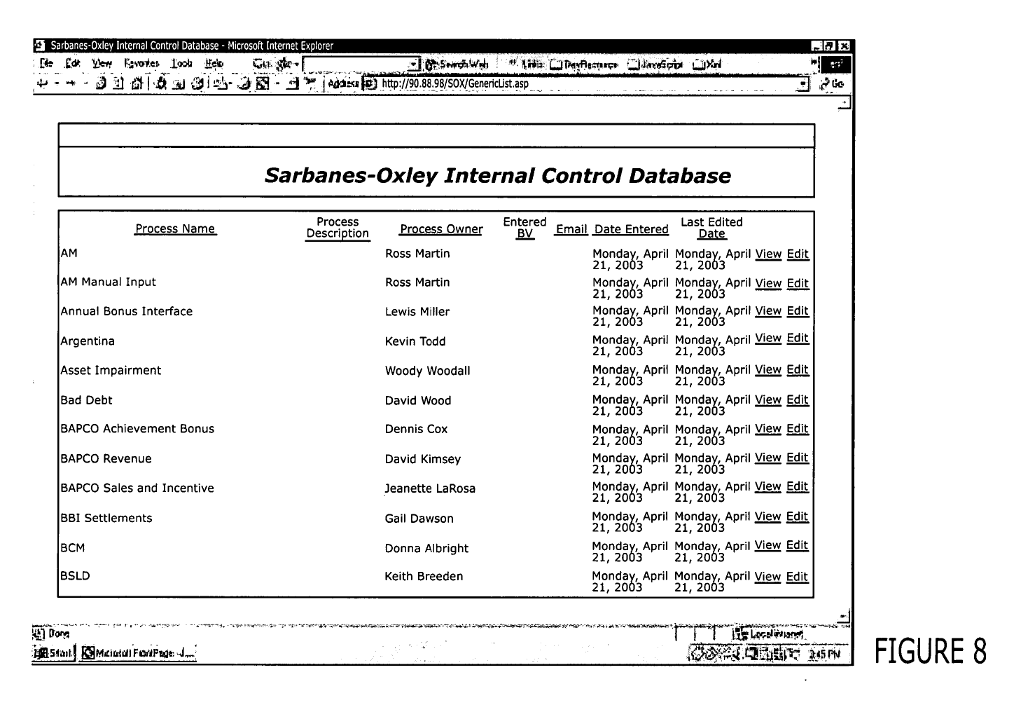

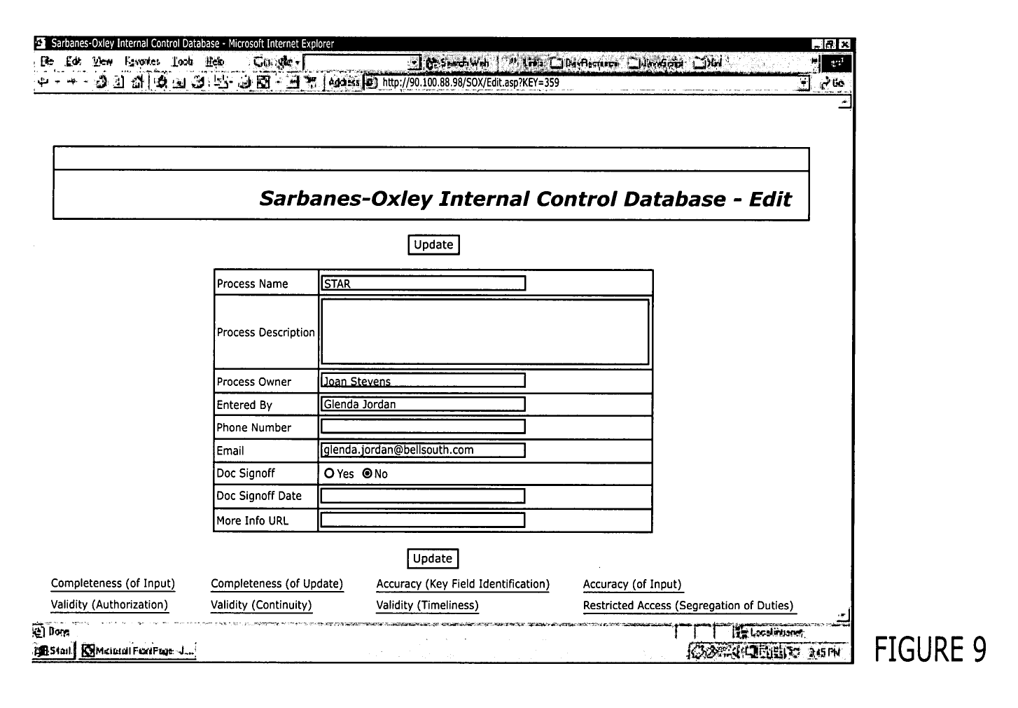

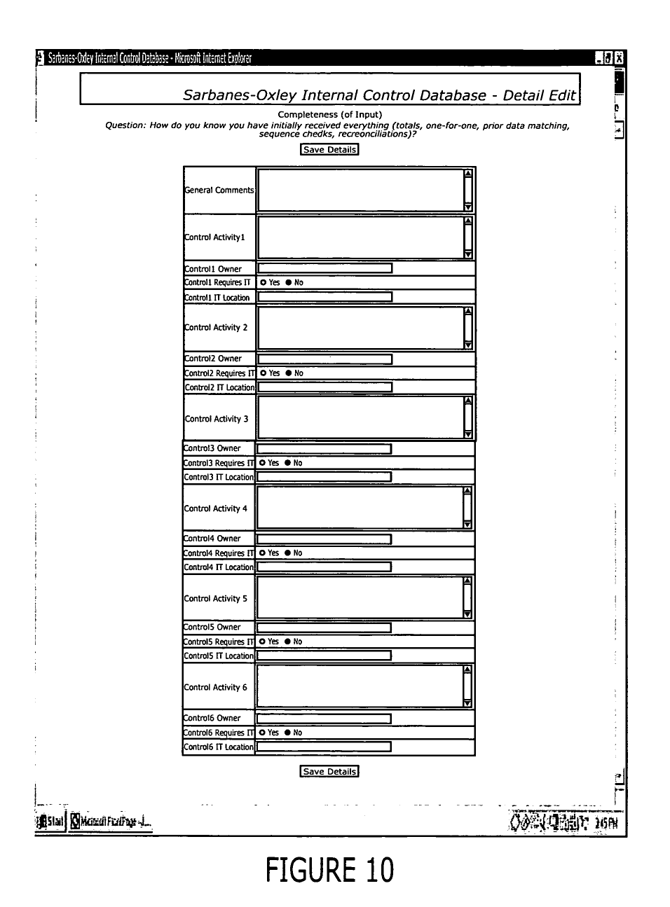

As discussed above, various embodiments of the present invention may be implemented in web-based or other network based data processing systems. An exemplary user access/view window for reviewing a database used in generating the aggregate report described above is illustrated in FIG. 8. An exemplary input screen for obtaining information about a source, such as a process generating financial data, is illustrated in FIG. 9. FIG. 10 illustrates an exemplary input window for obtaining information on one or more controls associated with a source, such as a process identified using the input screen of FIG. 9.

The flowchart and block diagrams of FIGS. 1 through 6 illustrate the architecture, functionality, and operations of some embodiments of methods, systems, and computer program products for generating an aggregate report to provide a certification of controls associated with a data set, such as financial data of a business entity. In this regard, each block represents a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A method for generating an aggregate report to provide a certification of controls associated with a data set, the method comprising:
identifying sources that generate information to be included in the data set;
identifying a plurality of controls associated with the identified sources;
selecting at least one of the controls as a key control;
testing the key control to assess its efficacy as a control for its identified source;
modifying the key control to adjust its efficacy based on the testing of the key control when the efficacy fails to satisfy a criterion; and
generating an aggregate report on the plurality of controls based on the testing of the key control to provide a certification of the controls associated with the data set.

2. The method of claim 1 wherein the data set comprises financial data for a business entity and wherein the business entity includes one or more business units having ownership of the identified sources and a financial unit and wherein:
identifying a plurality of controls comprises ones of the business units identifying controls associated with sources owned by the respective ones of the business units;
selecting at least one key control comprises the financial unit selecting the at least one key control;
testing the key control comprises the financial unit testing the key control; and
modifying the key control comprises the business unit having ownership of the key control modifying the key control.

3. The method of claim 1 wherein identifying sources that generate information comprises:
identifying primary sources that provide the information to be included in the data set;
identifying secondary sources that provide information to the identified primary sources for use in generating the information to be included in the data set.

4. The method of claim 1 wherein selecting at least one of the controls as a key control comprises:
determining at least one risk criterion; and
identifying at least one of the controls as a key control based on the at least one risk criterion.

5. The method of claim 1 wherein testing the key control comprises:
designing a test for the key control;
testing the key control based on the designed test; and
assessing the efficacy of the key control based on the testing of the key control.

6. The method of claim 1 wherein modifying the key control comprises:
providing training to an entity having ownership of the identified source associated with the key control; and
notifying the entity of the efficacy of the key control to provide the entity a basis to modify the key control.

7. The method of claim 1 further comprising:
analyzing a report generated from the data set to identify information included in the report that is not generated by the identified sources;
selecting and testing a key control for a source associated with information included in the report that is not generated by the identified sources; and
wherein generating the aggregate report further comprises generating the aggregate report based on the selected and tested key control for the source associated with information included in the report that is not generated by the identified sources.

8. A method for generating an aggregate report to provide a certification of controls associated with financial data for a business entity, the method comprising:
receiving an identification of a plurality of controls associated with sources that generate the financial data from at least one business unit of the business entity having ownership of the sources;
selecting at least one of the controls as a key control;
testing the key control to provide an assessment of its efficacy as a control for its associated source;
providing the assessment to the at least one business unit having ownership of the associated source when the key control fails to satisfy a criterion to allow modification of the key control to adjust its efficacy; and
generating an aggregate report on the plurality of controls, based on the testing of the at least one key control, for a manager of the business entity responsible for certification of the controls associated with the financial data.

9. The method of claim 8 wherein a financial unit of the business entity selects and tests the at least one key control and generates the aggregate report.

10. The method of claim 9 wherein the financial data comprises entries of a general ledger of the business entity and certifying controls comprises certifying controls associated with a financial report of the business entity generated based on the general ledger.

11. The method of claim 10 wherein the financial data further comprises a financial report from a business unit of the business entity.

12. The method of claim 11 wherein the business unit providing the financial report as financial data comprises a foreign subsidiary of the business entity.

13. The method of claim 10 further comprising identifying the sources that generate the financial data.

14. The method of claim 13 wherein identifying the sources that generate the financial data comprises:
identifying primary sources that provide the financial data; and
identifying secondary sources that provide information to the identified primary sources for use in generating the financial data.

15. The method of claim 14 wherein identifying the sources that generate the financial data further comprises identifying tertiary sources that provide information to the identified secondary sources for use in generating the information provided by the secondary sources to the primary sources.

16. The method of claim 10 wherein selecting at least one of the controls as a key control comprises:
determining at least one tolerance criterion; and
identifying at least one of the controls as a key control based on the at least one tolerance criterion.

17. The method of claim 16 wherein determining at least one tolerance criterion comprises determining a dollar criterion and a risk criterion and wherein identifying at least one of the controls as a key control comprises identifying controls that satisfy the dollar criterion and controls that satisfy the risk criterion as key controls.

18. The method of claim 17 wherein determining a risk criterion comprises determining a criterion based on risk of manual intervention generating an error in the financial data and/or a criterion based on a geographic location associated with a source of the financial data.

19. The method of claim 17 wherein the dollar criterion is based on revenue, asset flow, expenses and/or net income.

20. The method of claim 10 wherein selecting at least one of the controls as a key control comprises:
receiving information regarding the identified controls generated by the at least one business unit having ownership of the sources associated with the identified controls;
analyzing the received information to identify deficiencies in the received information;
requesting additional information regarding the identified controls generated by the at least one business unit having ownership of the sources associated with the identified controls to address any identified deficiencies in the received information; and
selecting at least one of the controls as a key control based on the received information and/or the additional information.

21. The method of claim 10 wherein selecting at least one of the controls as a key control comprises:
identifying a plurality of control categories; and
selecting at least one control from each of the identified control categories as a key control.

22. The method of claim 21 wherein the control categories comprise completeness of inputs to the general ledger, completeness of updates to the general ledger, accuracy of inputs to the general ledger, accuracy of updates to the general ledger, authorization, continuity, timeliness, access restriction and/or segregation of duties.

23. The method of claim 10 wherein testing the key control comprises:
designing a test for the key control;
testing the key control based on the designed test; and
assessing the efficacy of the key control based on the testing of the key control.

24. The method of claim 10 wherein modifying the key control comprises:
providing training to the at least one business unit having ownership of the source associated with the key control to the at least one business unit having ownership of the source associated with the key control; and
notifying the business unit having ownership of the source associated with the key control of the efficacy of the key control to provide the business unit having ownership of the source associated with the key control a basis to modify the key control.

25. The method of claim 10 further comprising:
analyzing the financial report of the business entity to identify information included in the financial report that is not generated by the identified sources;
selecting and testing at least one key control for a source associated with identified information included in the financial report that is not generated by the identified sources; and
wherein generating an aggregate report further comprises generating the aggregate report based on the selected and tested at least one key control for the source associated with identified information included in the financial report that is not generated by the identified sources.

26. The method of claim 10 wherein the business entity is a publicly held business entity and wherein the financial report comprises a report required by government regulations of publicly held business entities and wherein certifying controls comprises an assertion by management of the business entity that the controls associated with the financial report satisfy requirements specified by the government regulations.

27. The method of claim 10 wherein the sources comprise a process and/or a system of the business entity.

28. A system for generating an aggregate report to provide a certification of controls associated with a data set, the system comprising:
means for receiving an identification of controls associated with sources of information to be included in the data set and an identification of at least one entity having ownership of the sources;
means for receiving an identification of ones of the identified controls as key controls and for receiving verification of testing of the key controls; and
means for generating the aggregate report based on the verification of testing of the key controls.

29. The system of claim 28 further comprising means for registering users to control access to information used in generating the aggregate report.

30. The system of claim 28 wherein the means for receiving an identification of controls further comprises means for receiving a description of the sources of information.

31. The system of claim 28 wherein the means for receiving an identification of controls further comprises means for receiving a description of the controls.

32. The system of claim 31 wherein the description of the controls includes a designation of a control category for the controls.

33. The system of claim 28 wherein the data set comprises entries of a general ledger of the business entity and wherein the aggregate report is used to provide a certification of controls associated with a financial report of the business entity generated based on the general ledger.

34. A computer program product for generating an aggregate report to provide a certification of controls associated with a data set, comprising:
a computer readable medium having computer readable program code embodied therein, the computer readable program code comprising:
computer readable program code configured to receive an identification of controls associated with sources of information to be included in the data set and an identification of at least one entity having ownership of the sources;
computer readable program code configured to receive an identification of ones of the identified controls as key controls and for receiving verification of testing of the key controls; and
computer readable program code configured to generate the aggregate report based on the verification of testing of the key controls.
